(19) United States
(12) Patent Application Publication
(10) Pub. No.: US 2011/0145841 A1
(43) Pub. Date: Jun. 16, 2011

(54) SYSTEM AND METHOD FOR GENERATING PAGES OF CONTENT

(75) Inventors: John SHERWOOD, San Leandro, CA (US); Daniel PITTS, Concord, CA (US); Hunter BROWN, Oakland, CA (US); Daniel SCHMIDT, San Francisco, CA (US)

(73) Assignee: CBS INTERACTIVE, INC., San Francisco, CA (US)

(21) Appl. No.: 12/638,344

(22) Filed: Dec. 15, 2009

(51) Int. Cl. G06F 9/44

(52) U.S. Cl. 719/328

(57) ABSTRACT

Systems and methods for generating pages of content using API requests are described. Users can create web pages that are a collection of references to API queries. An example includes doors which are web pages that are portals to realms of content. Users can create doors by associating API references to a variety of previously created content assets which are called by the front-end to render the door when web users visit the door. The tool includes user interface elements that make creating and saving the API references easy. For example, pickers are provided for selecting API references to individual assets, query makers are provided for formulating previewing, merging and normalizing references to dynamic API searches, overriding functionality is provided for manually grooming the asset references returned by dynamic API searches or individual asset references, and the like.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to a system and method for generating pages of content.

2. Description of Related Art

The World Wide Web has become a primary source of communication amongst millions of individuals in recent years. Web pages are accessed by individuals for entertainment, education, information exchange, and even online shopping. As a result, more and more businesses have turned to the internet to market and advertise to potential customers, to disseminate information about their brands to the public, and to accept orders for their products and services.

Traditionally, websites were created by businesses via programmers who “hard coded” the sites using a combination of programming languages compatible with HyperText Markup Language (HTML). These programmers would create the site by writing lines of code describing how it should look and the content it should contain. The code would then be uploaded to a server, where it could be accessed by visitors to the website. Depending on the breadth of the site, it could often take many hours to generate a website in this fashion. Furthermore, it was very expensive for businesses to maintain over time due to the specialized knowledge needed by the programmer.

As technology progressed and businesses realized the high value of internet advertising, websites became more advanced, with more expansive content, multiple linked pages, and high-end graphics and videos. Due to the high costs involved in hiring web developers to code these advanced websites, software companies created website development programs capable of automating the web creation process. This software can be used to build websites either from scratch or from pre-existing templates. For example, a user can select, display, and arrange various web objects, such as text, graphics, media, etc., through the page, in a “what you see is what you get” fashion. Then, the software automatically codes the page into HTML, without the use of a web developer. Many of these website development programs also allow for day-to-day maintenance and update of the website after creation.

However, users of traditional website development software face many difficulties. For instance, the user must establish precise uniformity of the website despite the visual inaccuracies of the “drag and drop” format, requiring intense time, skill, and effort. For example, the user must ensure the correct proximity of display objects, alignment, and consistency of format. With respect to business websites, the user has to ensure uniformity across multiple, even hundreds or thousands, of linked web pages. Furthermore, this software often does not have the level of complexity required by many of today's businesses who want to integrate advanced functions, such as real-time media, into their sites. Thus, the website could become out-of-date and inconsistent, deteriorating the look and feel of the company website, and thus the visitor's representation of the company.

In both hard coding and in web development software, a web developer is needed to generate the website in accordance with the business's objectives. Typically, this means that editors, designers, and product managers, who have the most intimate understanding on the business, are not directly involved with the generation of the website, and must relay this information to the web developer. It may take a number of drafts and iterations before the editor or designer is satisfied that the website created by the developer properly reflects his or her desires and objectives for the website.

### SUMMARY OF THE INVENTION

Thus, there is a need in the art for systems and methods for generating pages of content that are easy-to-use, efficient, dynamic, allow for easy experimentation, and allow designers and editors direct control over the pages. Furthermore, there is a need for those pages to have consistent layouts and formats, if desired, without extreme difficulty and skill by the user.

This invention meets those needs and more by providing systems and methods for generating pages of content using API requests. Users can create web pages that are a collection of references to API queries. An example includes doors which are web pages that are portals to realms of content. Users can create doors by associating API references to a variety of previously created content assets which are called by the front-end to render the door when web users visit the door. The tool includes user interface elements that make creating and saving the API references easy. For example, pickers are provided for selecting API references to individual assets, query makers are provided for formulating previewing, merging and normalizing references to dynamic API searches, overriding functionality is provided for manually grooming the asset references returned by dynamic API searches or individual asset references, and the like.

In one embodiment, a computer-implemented method for generating pages of content is provided, comprising providing a user with a plurality of wireframes, the wireframes comprising a plurality of tiles; receiving a user selection of a wireframe; providing a user with a plurality of tiles; receiving a user selection of a plurality of tiles corresponding to the plurality of tiles in the selected wireframe; associating a plurality of API requests corresponding to a plurality of content assets with the selected plurality of tiles to generate an automated web page; and storing the automated web page. The method may further include one or more of the steps of previewing the automated web page, modifying the automated web page, publishing the automated web page, delivering the published automated web page to a device, modifying one or more of the selected plurality of tiles, and storing the selected wireframe and the plurality of selected tiles as a theme. One or more of the plurality of content assets may comprise one or more of text, an application, digital media, and an advertisement, and/or one or more of the plurality of selected tiles may be optimized. The plurality of wireframes may include a user-customizable wireframe.

In another embodiment, another computer-implemented method for generating pages of content is provided, comprising receiving a user request to access a web page, the web page comprising a plurality of API requests; generating an API request to access an automated web page; receiving the automated web page, the automated web page comprising a wireframe and a plurality of tiles, each tile having a plurality of API requests each corresponding to a request to retrieve a content asset; generating the plurality of API requests to retrieve the content assets; receiving the content assets; generating a web page that includes the content assets; and delivering the web page with the content assets to the user. The method may further include one or more of the steps of integrating the delivered web page into existing components of the third party website, determining one or more content assets to place into one or more optimized tiles, and determining one or more locations for the one or more optimized tiles. The user may optionally be a device or a third party website. One or more of the plurality of content assets may comprise one or more of text, an application, digital media, and an advertisement, and may be determined based on a user profile of the user based on the user's actions.

Still other aspects, features and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a flowchart illustrating a method according to one embodiment.

FIG. 2 is another flowchart illustrating a method according to one embodiment.

FIG. 3A is a screen shot of a user interface for implementing the method according to one embodiment.

FIG. 3B is a screen shot of a preview created via the user interface of FIG. 3A according to one embodiment.

FIG. 4A is a screen shot of a user interface for implementing the method according to one embodiment.

FIG. 4B is a screen shot of a preview created via the user interface of FIG. 4A according to one embodiment.

FIGS. 5A-C are screen shots of web pages created and delivered to various destinations via the method according to one embodiment.

FIG. 6 is a representative schematic illustrating a system according to one embodiment.

FIG. 7 is a schematic diagram of an exemplary computer system according to one embodiment of the invention.

### DETAILED DESCRIPTION

A system and method for generating pages of content is described. In the following description, for purposes of explanation, numerous specific details are set forth in order to provide a thorough understanding of the exemplary embodiments. It is apparent to one skilled in the art, however, that the present invention can be practiced without these specific details or with an equivalent arrangement. In some instances, well-known structures and devices are shown in block diagram form in order to avoid unnecessarily obscuring the preferred embodiment.

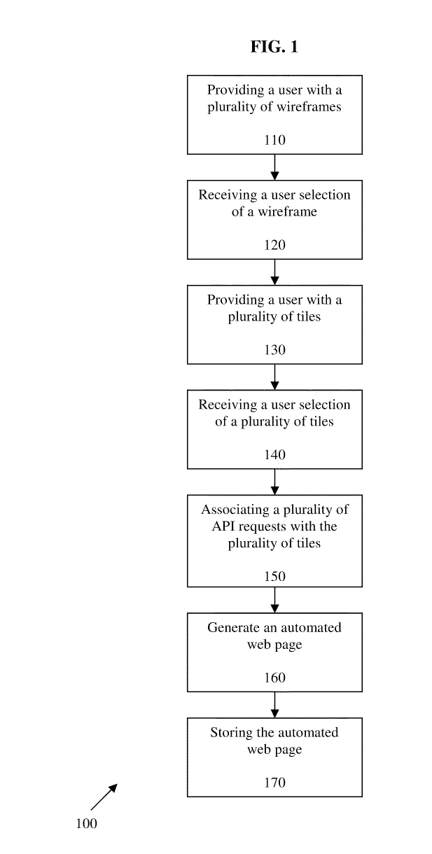

Referring now to the drawings, wherein like reference numerals designate identical or corresponding parts throughout the several views, FIG. 1 is a flowchart 100 illustrating a method according to one embodiment. At processing block 110, the user is provided with a plurality of wireframes. As shown and described below, the wireframes are skeletal adaptations of cross-linked web page prototypes without media or other page substance. At processing step 120, a user selection of a wireframe is received.

At processing block 130, the user is provided with a plurality of tiles, also referred to as containers. The tiles represent different areas of the wireframe containing different content. At processing block 140, a user selection of a plurality of tiles corresponding to the wireframe is received. The user can add or delete tiles, resize them, and move them around the page to try different layouts.

At processing block 150, a plurality of application programming interface (API) requests corresponding to a plurality of content assets is associated with the plurality of tiles. The content assets may be static or dynamic, and may contain text, applications, or any type of digital media, such as images, audio, video, and the like. At processing block 160, an automated web page is generated based on the API requests. At processing block 170, the automated web page is stored, and may be used as a pre-built theme for future web pages, as shown and described below, or can be published and delivered to any destination or device.

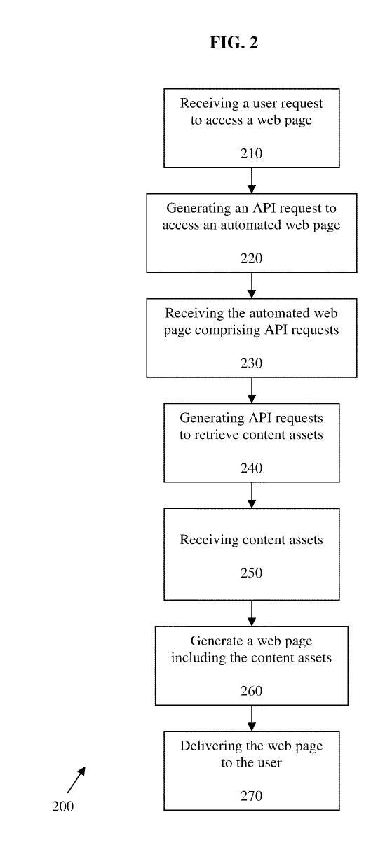

FIG. 2 is a flowchart 200 illustrating another method according to one embodiment. At processing block 210, a user request to access a web page is received. The web page comprises a plurality of API requests. At processing block 220, an API request to access an automated web page is generated.

At processing block 230, the automated web page is received. The automated web page comprises a plurality of API requests, and each API request corresponds to a request to retrieve a content asset. As discussed above, the content asset may be static or dynamic, and may contain text, applications, or any type of digital media, such as images, audio, video, and the like. At processing block 240, the plurality of API requests are generated to retrieve the requested content assets, and at processing block 250, the content assets are received.

At processing block 260, a web page is generated that includes the requested content assets. At processing block 270, the web page with the content assets is delivered to the user. The web page can then be used as a pre-built theme for future web pages, as shown and described below, or can be published and delivered to any destination or device.

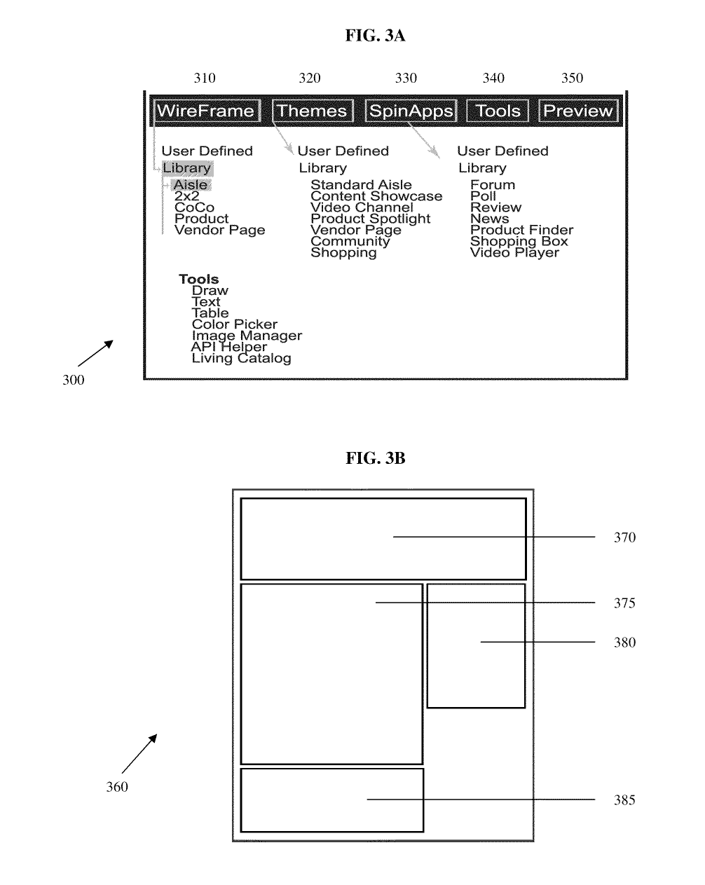

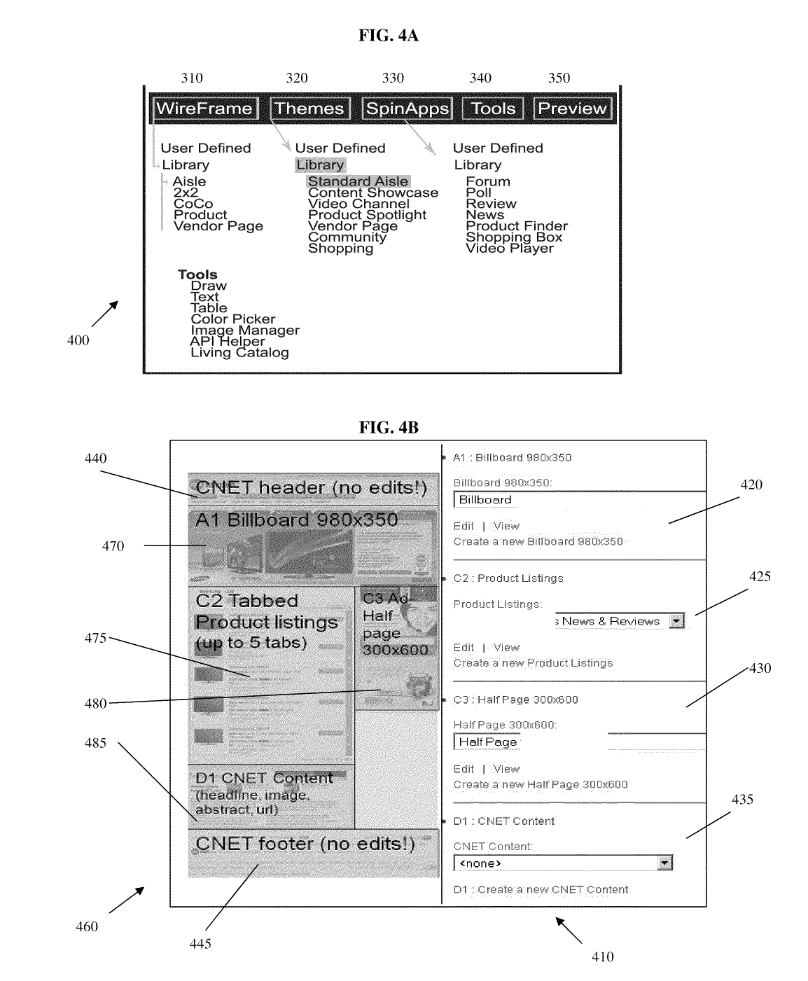

FIG. 3A is a screen shot of user interface 300 for implementing the method according to one embodiment. User interface 300 has five headings: WireFrame 310, Themes 320, SpinApps 330, Tools 340, and Preview 350. Any and/or all of the headings may be selected to display a drop-down menu with two options: user defined and library. The library option may be selected to display a further drop-menu with a plurality of further options.

WireFrame 310 is selected to add wireframes to a web page. Wireframes are skeletal adaptations of cross-linked web page prototypes without media or other page substance. A wireframe can include one or more tiles, also referred to as containers, that represent the location and orientation of content assets. The content assets may be static or dynamic, and may contain text, applications, or any type of digital media, such as images, audio, video, and the like.

A user can create his or her own wireframe by selecting the “user defined” option from the drop-down menu of WireFrame 310. Then, the user can add or delete tiles, resize them, and move them around the page to try different page layouts. Alternatively, a user can select a pre-built wireframe from the library by selecting one of the pre-built wireframe titles (in this example: Aisle, 2×2, CoCo, Product, Vendor Page). A pre-built wireframe may be created and added to the library by a user solely for the purpose of providing a template for future web pages, or may be created and added by a user in the process of building a previous web page.

Themes 320 is selected to apply a theme to the web page. In this example, a theme is a design/style template for the web page that may control such attributes as font, font size, font color, content asset size, content asset layout, background color, headings, etc., and combinations thereof. A user can create his or her own theme via Cascading Style Sheet (CSS) by selecting the “user defined” option from the drop-down menu of Themes 320. Alternatively, a user can select a CSS design overlay or pre-built design/content page template from the library by selecting one of the pre-built theme titles (in this example: Aisle, Content Showcase. Video Channel, Product Spotlight, Vendor Page, Community, Shopping). A pre-built theme may be created and added to the library by a user solely for the purpose of providing a template for future web pages, or may be created and added by a user in the process of building a previous web page.

SpinApps 330 is selected to plug content assets into each tile of the web page. As discussed previously, a content asset may be static or dynamic, and may contain text, applications, or any type of digital media, such as images, audio, video, and the like. A user can create and/or add his or her own content asset to the web page by selecting the “user defined” option from the drop-down menu of SpinApps 330. Alternatively, a user can select one or more pre-built content assets from the library by selecting one or more of the pre-built content asset titles (in this example: Forum, Poll, Review, News, Product Finder, Shopping Box, Video Player). A pre-built content asset may be created and/or added to the library by a user solely for the purpose of providing content assets available for future web pages, or may be created and/or added by a user in the process of building a previous web page.

Tools 340 is selected to perform miscellaneous other functions to the web page. For instance, in this embodiment, Tools 340 can be selected for the following functions: Draw, Text, Table, Color Picker, Image Manager, API Helper, Living Catalog. These tools are merely illustrative in nature. It is contemplated that any number of other web page creation, modification, and/or publication tools can be added to Tools 340.

Preview 350 can be selected at any point in the web page building process in order to display a preview of the web page at that moment. In this embodiment, the “Aisle” wireframe is selected to the web page from the library of WireFrame 310. FIG. 3B shows a preview of web page 360 with the “Aisle” wireframe applied. Web page 360 has tiles 370, 375, 280, and 385 arranged and laid out as shown.

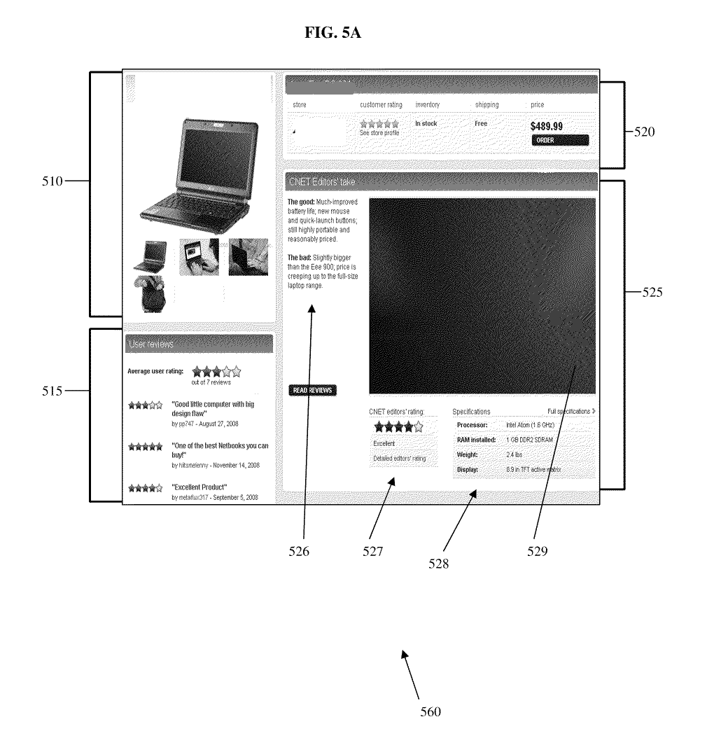

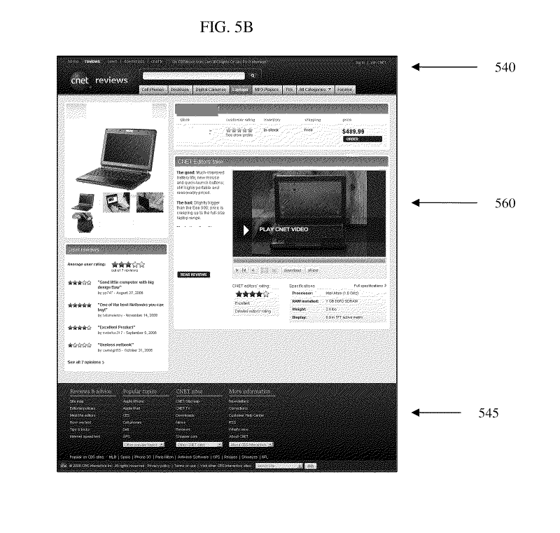

FIG. 4A is a screen shot of user interface 400 for implementing the method according to one embodiment. User interface 400 has five headings: WireFrame 310, Themes 320, SpinApps 330, Tools 340, and Preview 350, as described above. In this embodiment, the “Standard Aisle” theme is selected to be applied to the web page from the library of Themes 320. Whereas the wireframe defines only the layout and tiles, themes can define just the design (i.e. color, fonts, etc., as described with respect to FIG. 3A), or the design plus the layout, functionality, content assets, data modules, advertising units, and even the destination elements, including a website's header and footer, as described further herein.

FIG. 4B shows a preview of web page 460 with the “Standard Aisle” theme applied. In this example, the “Standard Aisle” theme defines the design and the layout to include all the elements needed to create, manage, and publish a “standard aisle”. For example, web page 460 is pre-built with tiles 470, 475, 480, and 485, which are assigned to a billboard, tabbed product listings, a half-page ad, and site content, respectively. Each of tiles 470, 475, 480, and 485 have pre-defined sizes, content, and/or limitations. For example, billboard tile 470 has a pre-defined size of 980×350 pixels, tabbed product listings tile 475 is limited to 5 tabs, half-page ad tile 480 is limited to 300×600 pixels, and site content the 485 contains the site headline, image, abstract, and URL. These pre-defined sizes, content, and/or limitations allow for optimal uniformity across multiple web pages created using the “Standard Aisle” theme, if desired by the user.

The “Standard Aisle” theme further applies destination elements to web page 460. For example, web page 460 is pre-built with header 440 of the destination website, and footer 445 of the destination website. However, in other embodiments, these destination elements are not required. Furthermore, in other embodiments, pre-built themes, such as the “Standard Aisle” theme, can be used as a baseline for editing and modification, wherein the user can create and/or add his or her own content assets to provide additional functionality to the web page.

FIG. 4B also shows user customization interface 410 for web page 460. User customization interface 410 allows the user to further customize each of tiles 470, 475, 480, and 485, via customization boxes 420, 425, 430, and 435. User customization interface 410 has at least one customization box corresponding to each tile. For example, customization box 420 can be used to modify tile 470, customization box 425 can be used to modify tile 475, and so on. Furthermore, customization boxes 420, 425, 430, and 435 can be used to select pre-defined content assets from the library for each corresponding tile, or to create and add a new content asset to the corresponding tile. In one embodiment, customization box 430 can further be used to select a variable advertisement option (not shown) that allows the system to select an advertisement to display in half-page ad tile 480 at a future time, such as when the published web page is accessed by a user.

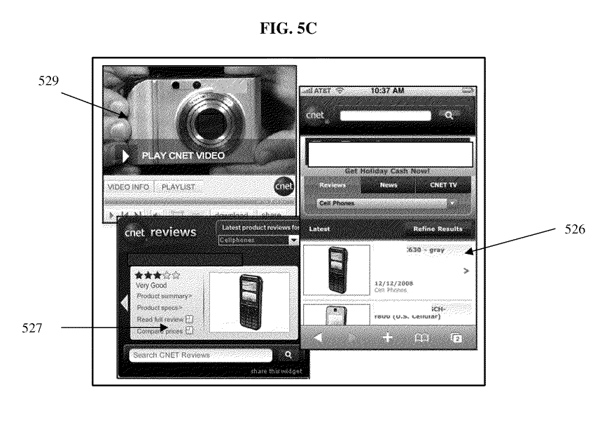

FIG. 5A shows a preview of web page 560 with a product spotlight theme applied, including photo tile 510, user review tile 515, sales tile 520, and editor tile 525. The tiles may have a plurality of content assets plugged into them. For example, editor tile 525 has review asset 526, rating asset 527, product specification asset 528, and video asset 529.

In FIG. 5B, web page 560 has been published and delivered to a destination website. In this example, web page 560 has been integrated into the destination website and its existing header 540 and existing footer 545. In FIG. 5C, web page 560 and/or its tiles and/or components have been delivered to other various destinations. For example, video asset 529 has been delivered to a file sharing website, while rating asset 527 has been delivered to a widget, and review asset 526 has been delivered to a mobile device.

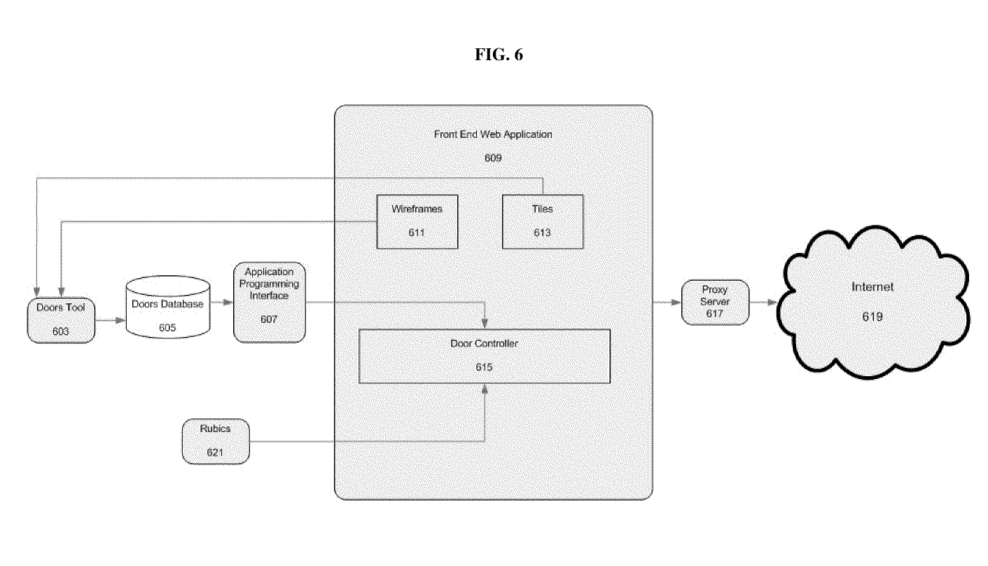

FIG. 6 shows a representative schematic illustrating a system according to one embodiment. In a first embodiment, a user may access the system via doors tool 603 in order to create and/or publish a web page. Doors tool 603 proceeds to request a list of wireframes 611 and tiles 613 from front end web application 609. Upon receipt of wireframes 611 and tiles 613, doors tool 603 then presents a form by which the user can select wireframes and tiles. Doors tool 603 then prompts the user to select assets, or to query for assets. A query for assets can be made by, for example, text search, date, identification number, etc. Once the wireframes, tiles, and assets are selected, they are pulled from doors database 605, put together by application programming interface 607, and sent to door controller 615. Application programming interface 607 may be, for example, a collection of HTTP-based web services with well-defined protocols. Door controller 615 receives the web page from application programming interface 607 and determines whether any tiles selected by the user are so-called “rubics optimized”, in which case rubics component 621 chooses which asset(s) to place into the optimized tile(s), in what location to place them, in what order, etc. Front end web application 609 then renders the web page into a readable language, such as, for example, HTML, and sends the rendered web page to one or more proxy servers 617 for caching and optimization, then to the internet 619.

In another embodiment, a user may access the system through front end web application 609 by requesting a specific web page. In this embodiment, door controller 615 makes a request for that particular web page to doors tool 603 via front end web application 609. Doors tool 603 receives a list of wireframes 611 and tiles 613, selects the appropriate wireframes 611 and tiles 613 from doors database 605 based on instructions from door controller 615, matches assets to tiles 613, and sends all of the selected parts to application programming interface 607. Application programming interface 607 puts the web page together, and sends it to door controller 615. Door controller 615 receives the web page and determines whether any tiles selected by the user are so-called “rubics optimized”, in which case rubics component 621 chooses which asset(s) to place into the optimized tile(s), in what location to place them, in what order, etc. Rubics component 621 may select assets and make further determinations about the assets randomly, according to set instructions, or variably according to the user that requested the web page. In the latter example, rubics 621 may target the user by, for example, making inferences about the user based on the user's actions, such as is described in U.S. patent application Ser. No. 12/559,455, filed Sep. 14, 2009, herein incorporated by reference in its entirety. Front end web application 609 then renders the web page into a readable language, such as, for example, HTML, and sends the rendered web page to one or more proxy servers 617 for caching and optimization, and then to the internet 619 for viewing by the requesting user.

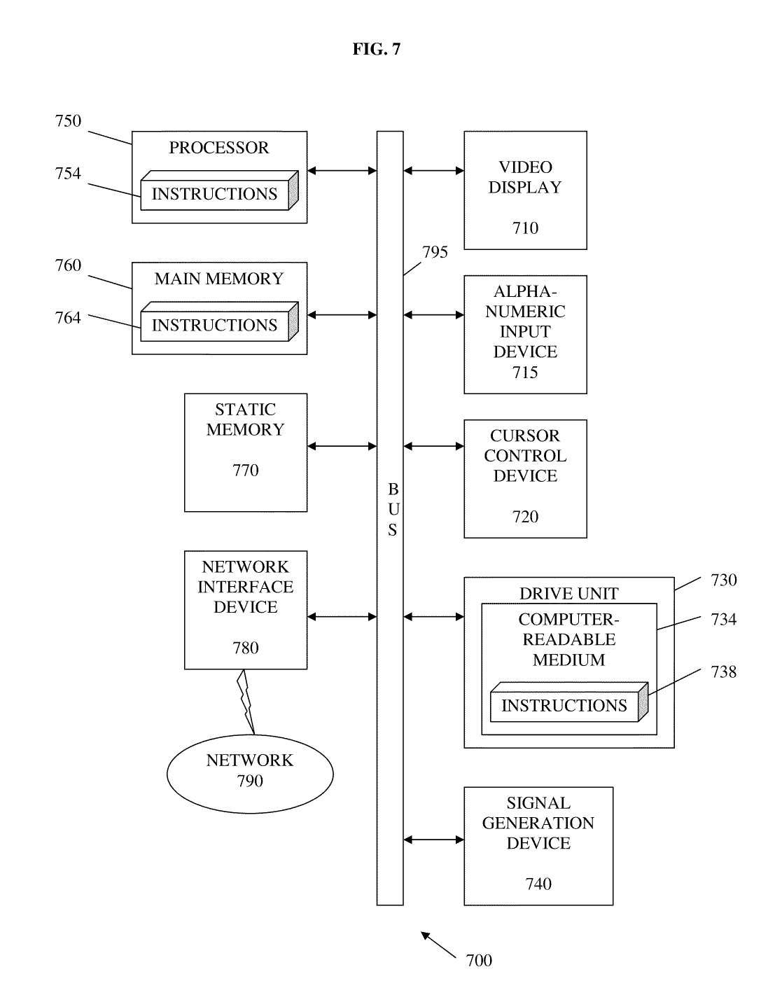

FIG. 7 shows a diagrammatic representation of a machine in the exemplary form of computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 700 includes processor 750 (e.g., a central processing unit (CPU), a graphics processing unit (GPU) or both), main memory 760 (e.g., read only memory (ROM), flash memory, dynamic random access memory (DRAM) such as synchronous DRAM (SDRAM) or Rambus DRAM (RDRAM), etc.) and static memory 770 (e.g., flash memory, static random access memory (SRAM), etc.), which communicate with each other via bus 795.

Computer system 700 may further include video display unit 710 (e.g., a liquid crystal display (LCD) or a cathode ray tube (CRT)). Computer system 700 also includes alphanumeric input device 515 (e.g., a keyboard), cursor control device 720 (e.g., a mouse), disk drive unit 730, signal generation device 740 (e.g., a speaker), and network interface device 780.

Disk drive unit 730 includes computer-readable medium 734 on which is stored one or more sets of instructions (e.g., software 738) embodying any one or more of the methodologies or functions described herein. Software 738 may also reside, completely or at least partially, within main memory 760 and/or within processor 750 during execution thereof by computer system 700, main memory 760 and processor 750 also constituting computer-readable media. Software 738 may further be transmitted or received over network 790 via network interface device 780.

While computer-readable medium 734 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, and optical and magnetic media.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

The invention is achieved by manipulating data structures and transforming the data from one form, useable by a computer for one purpose, to another form, useable by a computer for another purpose.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer-implemented method for generating pages of content comprising:
providing a user with a plurality of wireframes, the wireframes comprising a plurality of tiles;
receiving a user selection of a wireframe;
providing a user with a plurality of tiles;
receiving a user selection of a plurality of tiles corresponding to the plurality of tiles in the selected wireframe;
associating a plurality of API requests corresponding to a plurality of content assets with the selected plurality of tiles to generate an automated web page; and
storing the automated web page.

2. The computer-implemented method of claim 1, further comprising previewing the automated web page.

3. The computer-implemented method of claim 2, further comprising modifying the automated web page.

4. The computer-implemented method of claim 2, further comprising publishing the automated web page.

5. The computer-implemented method of claim 4, further comprising delivering the published automated web page to a device.

6. The computer-implemented method of claim 1, further comprising modifying one or more of the selected plurality of tiles.

7. The computer-implemented method of claim 1, wherein one or more of the plurality of content assets comprises one or more of text, an application, digital media, and an advertisement.

8. The computer-implemented method of claim 1, wherein one or more of the plurality of selected tiles is optimized.

9. The computer-implemented method of claim 1, wherein the plurality of wireframes includes a user-customizable wireframe.

10. The computer-implemented method of claim 1, further comprising storing the selected wireframe and the plurality of selected tiles as a theme.

11. A computer-implemented method for generating pages of content comprising:
receiving a user request to access a web page, the web page comprising a plurality of API requests;
generating an API request to access an automated web page;
receiving the automated web page, the automated web page comprising a wireframe and a plurality of tiles, each tile having a plurality of API requests each corresponding to a request to retrieve a content asset;
generating the plurality of API requests to retrieve the content assets;
receiving the content assets;
generating a web page that includes the content assets; and
delivering the web page with the content assets to the user.

12. The computer-implemented method of claim 11, wherein the user is a device.

13. The computer-implemented method of claim 11, wherein the user is a third party website.

14. The computer-implemented method of claim 13, further comprising integrating the delivered web page into existing components of the third party website.

15. The computer-implemented method of claim 11, wherein one or more of the plurality of content assets comprises one or more of text, an application, digital media, and an advertisement.

16. The computer-implemented method of claim 11, wherein one or more of the plurality of tiles is optimized.

17. The computer-implemented method of claim 16, further comprising determining one or more content assets to place into the one or more optimized tiles.

18. The computer-implemented method of claim 17, wherein the one or more content assets are determined based on a user profile of the user based on the user's actions.

19. The computer-implemented method of claim 16, further comprising determining one or more locations for the one or more optimized tiles.
